(19) United States
(12) Patent Application Publication
(10) Pub. No.: US 2018/0015955 A1
(43) Pub. Date: Jan. 18, 2018

(54) CHASSIS & METHOD

(71) Applicant: SSAB TECHNOLOGY AB, Stockholm (SE)

(72) Inventor: Anders ISAKSSON, Falun (SE)

(21) Appl. No.: 15/516,510

(22) PCT Filed: Oct. 3, 2014
(86) PCT No.: PCT/EP2014/071260

§ 371 Date: Apr. 3, 2017

(51) Int. Cl. B62D 21/20; B62D 21/02

(52) U.S. Cl. CPC B62D 21/20; B62D 21/02

(57) ABSTRACT

Chassis (21) comprising at least one wheel (26), and a plurality of side members (22, 23) each comprising an upper flange (32) and a lower flange (33) that extend in a longitudinal direction of the chassis (21). The chassis (21) comprises a centre flange (34) that is located between the upper flange (32) and the lower flange (33) and extends in the longitudinal direction of the chassis (21), and at least one cross member (24) that extends in a lateral direction of the chassis (21) which is connected between a centre flange (34) of a first side member (22) of the plurality of side members (22, 23) and a centre flange (34) of a second side member (23) of the plurality of side members (22, 23).

### TECHNICAL FIELD

The present invention concerns a chassis comprising at least one wheel, such as vehicle chassis, a rolling chassis, a trailer chassis, or any other chassis that is to be towed by pulling means. The present invention also concerns a method for manufacturing such a chassis.

### BACKGROUND OF THE INVENTION

A chassis is a structural member that constitutes an internal framework for supporting one or more objects. An example of a chassis is the underpart of a motor vehicle, which consists of the frame on which the vehicle body is mounted. If running gear, such an engine, wheels, transmission, and suspension are included, then the assembly is sometimes described as a rolling chassis.

British patent application no. GB 1 314 422 discloses a vehicle chassis comprising two longitudinally extending structural members each of which has two elongate plate-like flanges that extend in the longitudinal direction of the vehicle chassis and which are spaced apart and interconnected by a web corrugated in the longitudinal direction such that the line of interconnection of the web and each flange defines a wave.

U.S. Pat. No. 3,940,162 describes a load-bearing structural member comprising an upper plate member, a lower plate member spaced a distance X from the upper plate member, and a reinforcing web comprising a plurality of web segments extending back and forth between the web segments in zigzag fashion. The web segments meet the plate members at a web angle, θ wherein the magnitude of the two variables X and θ are varied over the length of the structural member in accordance with the weight, strength, and shape requirements of particular sections thereof.

German patent no. DE 10148312 concerns carrier frame that has a pair of relatively spaced longitudinal supports extending in the vehicle longitudinal direction, coupled via transverse supports. Each longitudinal support has upper and lower members joined by a number of vertical elements, whereby each lower member is divided into a front section, a central section and a rear section, with auxiliary transverse supports between the central sections of both longitudinal supports forming a platform for an engine block, fitted to the carrier frame as a pre-assembled unit.

British patent application no. GB 2034792 discloses a structural element consisting of a pair of chords and a web in the form of a zigzag strip consisting of oblique straights alternating with crests by which the web is joined to, and between the chords. Each of the crests is a flat of parallelogrammatic form and has the larger of the supplementary angles of the parallelogram between 120° and 150°. Each of the straights has its major cross-sectional dimension extending in a plane parallel to that of the chords or at least having a component parallel to the plane of the chords.

International publication no. WO 2011/111510 describes a floor structure of a trailer that can reduce the number of assembly steps and lighten a vehicle body. The floor structure is provided with main beams that extend in the lengthwise direction of the trailer and a plurality of floor members extend in the lengthwise direction. A planar structure is formed by linking the main beams and the floor members in the widthwise direction of the trailer. The main beams and the floor members comprise long aluminum alloy members.

### SUMMARY OF THE INVENTION

An object of the invention is to provide an improved chassis.

This object is achieved by a chassis comprising at least one wheel, and a plurality of side members, which may optionally extend parallel to one another. Each side member comprises an upper flange and a lower flange that extend in a longitudinal direction of the chassis. The chassis comprises a centre flange that is located between the upper flange and the lower flange and extends in the longitudinal direction of the chassis. The chassis also comprises at least one cross member that extends in a lateral direction of the chassis and that is connected between a centre flange of a first side member of the plurality of side members and a centre flange of a second side member of the plurality of side members.

The centre flange provides stiffness and strength in the lateral direction of each side member. Such a construction also imparts further strength and stability to the chassis since the upper and lower flanges of a chassis are usually subjected to the greatest stress when the chassis is in use. By providing at least one cross member between the centre flanges of at least two side members, the cross members will for example cooperate with the floor of the chassis to provide greater torsional rigidity.

According to an embodiment of the invention at least one of the upper flange, the lower flange and/or the centre flange have a continuous extension along the whole of a side member's length, i.e. each flange constitutes a single non-spliced structural component. By providing at least one of the flanges as in a single piece means that the risk of fractures at the joints of spliced flanges are avoided. One or more of a chassis' side members may however comprise one or more spliced flanges.

According to an embodiment of the invention the at least one cross member comprises a straight or curved rib, a flat, curved or corrugated plate or web plate, a uniform or non-uniform lattice structure or any other suitable connecting component or structure. The at least one cross member may be of any shape and size and have any suitable cross section and thickness. An advantage of using a plate or a web plate is that a thin plate can be used since the centre flange can be used to support and reinforce the web plate where components are bolted to the chassis frame, which saves weight and costs. Such a cross member may comprise at least one weight-saving recess.

According to an embodiment of the invention the centre flange of a side member extends in parallel with at least one of the upper flange or the lower flange. However, two or more of the flanges of a side member according to the present invention do not necessarily need to be parallel. The flanges need not necessarily extend in a straight line but may comprise curved, bent and/or angled portions as desired. A lower flange of a side member may for example be arranged to bend upwards at a leading edge thereof in order to provide space for a pulling means, such as for a vehicle's trailer attachment assembly.

According to an embodiment of the invention the at least one cross member is arranged to be clamped between a centre flange of a first side member of said plurality of side members and a centre flange of a second side member of said plurality of side members, i.e. an end of a cross member may be clamped onto the centre flange of a side member.

According to an embodiment of the invention the chassis is a vehicle chassis, a rolling chassis or a chassis that is to be towed by pulling means. The chassis can be arranged for driving, or being driven, on a road or some other surface, or on rails. Such a chassis may be used particularly, but not exclusively, in mining, construction, agriculture, earth moving, manufacturing industries, the railroad industry, the automobile industry, the forestry industry, metal producing or automotive applications.

The present invention also concerns a method for manufacturing a chassis according to any of the embodiment of the present invention, namely a chassis comprising at least one wheel, and a plurality of side members each comprising an upper flange and a lower flange that extend in a longitudinal direction of the chassis. One or more side members may optionally be provided with one or more wheel suspension mountings on which at least one wheel is mounted. The method comprises the step of mounting a centre flange between the upper flange and the lower flange of each side member which centre flange extends in the longitudinal direction of the chassis, and connecting at least one cross member that extends in a lateral direction of the chassis between a centre flange of a first side member of the plurality of side members and a centre flange of a second side member of the plurality of side members. It should be noted that the steps of the method according to the present invention may be carried out in any suitable order and not necessarily in the order recited in the claims.

In order to achieve a durable chassis, only screw-, rivet- and possibly adhesive joints are preferably used to connect the components constituting a side member.

According to an embodiment of the invention the method comprises the step of manufacturing at least one of the upper flange, the lower flange and/or the centre flange to have a continuous extension along the whole of a side member's length.

According to an embodiment of the invention the at least one cross member comprises a rib, a plate or a lattice structure.

According to an embodiment of the invention the method comprises the step of arranging the centre flange of a side member to extend in parallel with at least one of the upper flange or the lower flange.

According to an embodiment of the invention the method comprises the step of clamping said at least one cross member between a centre flange of a first side member of said plurality of side members and a centre flange of a second side member of said plurality of side members.

According to an embodiment of the invention the chassis is a vehicle chassis, a rolling chassis or a chassis that is to be towed by pulling means.

### BRIEF DESCRIPTION OF THE DRAWINGS

The present invention will hereinafter be further explained by means of non-limiting examples with reference to the appended schematic figures where;

FIG. 1 shows a perspective view of a trailer chassis according to an embodiment of the invention,

FIG. 2 shows a side view of a trailer chassis according to an embodiment of the invention,

FIG. 3 shows a view of a trailer chassis according to an embodiment of the invention from above,

FIG. 4 shows cross members provided between the centre flanges of two adjacent side members of a chassis according to an embodiment of the invention, and

FIG. 5 is a flow chart showing the steps of a method according to an embodiment of the invention.

It should be noted that the drawings have not necessarily been drawn to scale and that the dimensions of certain features may have been exaggerated for the sake of clarity.

### DETAILED DESCRIPTION OF EMBODIMENTS

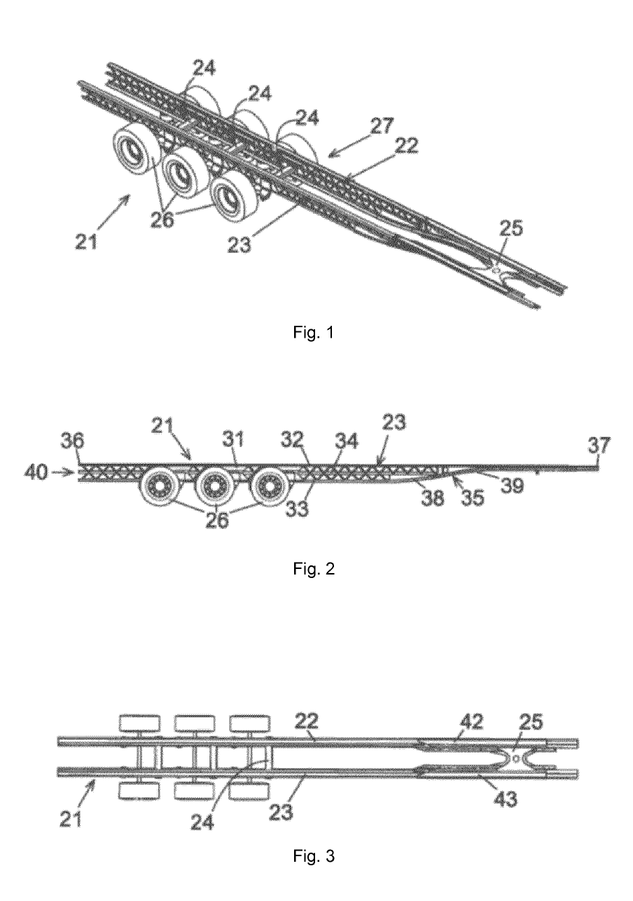

FIG. 1 shows a trailer chassis 21 according to the present invention. The trailer chassis comprises two side members 22, 23 which extend in parallel to one another. Each side member 22, 23 comprises an upper flange 32, a lower flange 33 and a centre flange 34 and the centre flanges 34 of the two side members 22, 23 are connected to each other via a plurality of cross members 24.

A connection means 25 for a towing means, such as a road-going vehicle is connected to the side members' front ends. These side members 22, 23 are continuous along the whole of their length, i.e. they are not spliced anywhere along their length. In the illustrated embodiment the trailer 21 is provided with three pairs of wheels 26 which are connected to the side members 22, 23, whereby the side members 22, 23 and the wheel pairs' suspension mountings define a trailer chassis 27. The side members 22, 23 according to the present invention may comprise metal, such as steel, plastic, a composite material, or any other suitable material or combination of materials.

FIG. 2 shows a side view of the trailer chassis 21 with the three wheel pairs 26 connected to a side member 23. Each of these wheel pairs 26 is connected to both side members 22, 23 via wheel undercarriage plates 31 which are connected to the upper flange 32, to the lower flange 33, and to the centre flange 34 that is mounted between the upper flange 32 and the lower flange 33 and extends in parallel with flanges in the rear part of each side member 22, 23 up to the so called gooseneck 35, i.e. the upward-bending portion at the leading end of the lower flange 33 which is arranged to provide space for a pulling means, such as a vehicle's trailer attachment assembly.

As can be seen from FIG. 2 all of the flanges 32, 33, 34 are provided in one piece with an extension along the whole of the trailer chassis' length from its rear end 36 to its front end 37 without any joints. The lower flange 33 has two oppositely directed curved portions 38, 39 which form the gooseneck 35. Both curved portions are located in front of said wheel pairs 26 so that the lower flange's 33 perpendicular distance to the upper flange 32 at the trailer chassis rear end 36 is greater than the corresponding perpendicular distance to the upper flange 32 at the trailer chassis' front end 37. Furthermore, the upper flange 32 and the lower flange 33 are connected to one another via at least one connecting member 40, such as a rib, plate or lattice structure, along the whole of the side member's length, i.e. from its rear end 36 to its front end 37.

The at least one connecting member 40 may comprise a first upper connecting member located between the upper flange 32 and the centre flange 34 and a second lower connecting member located between the lower flange 33 and the centre flange 34. It should be noted that a side member 22, 23 of a chassis according to the present invention need not necessarily comprise the same connecting members 40 along the whole of its length. Furthermore, the flanges 32, 33, 34 of a side member 22, 23 need not all necessarily be of uniform thickness, or made of the same material or be uniformly spaced from one another along their length in the region outside the gooseneck 35.

An upper connecting member may for example be provided as a number of extendable or compressible elements in the form of struts which at one end are connected to the upper flange 32 and at their second end are connected to the centre flange 34. Each strut may be provided as an extruded strut or as a cast strut. The struts are preferably connected to the upper flange 32 and to the centre flange 34 at an angle α=45° in order to form a lattice therebetween. Any suitable angle may however be selected, such as 30°<α<60°. In a corresponding way, a lower connecting member may be provided as a number of similar struts which are connected to the lower flange 33 at one end and to the centre flange 34 at their other end. Each strut may also be provided as an extruded strut or a cast strut in the lower connecting member. The struts are preferably connected to the lower flange and to the centre flange at an angle α=45° to form a lattice therebetween. Again, any suitable angle may be selected, such as 30°<α<60°. Each connection between the side member and the connecting member may be in the form of a rivet- or screw-joint.

FIG. 3 shows the trailer 21 from above with the centre flanges of the parallel side members 22, 23 connected with three cross members 24. The connection means 25 is connected to the side members' front parts via beam-reinforcement elements 42, 43 which have an extension over and along a larger part of the narrow front part of each side member, i.e. the part from the gooseneck to the front end of each side member. It should be noted that the connecting members that interconnect the flanges 32, 33, 34 may extend outside of the vertical plane of the flanges 32, 33, 34 on the inside and/or outside of the trailer 21.

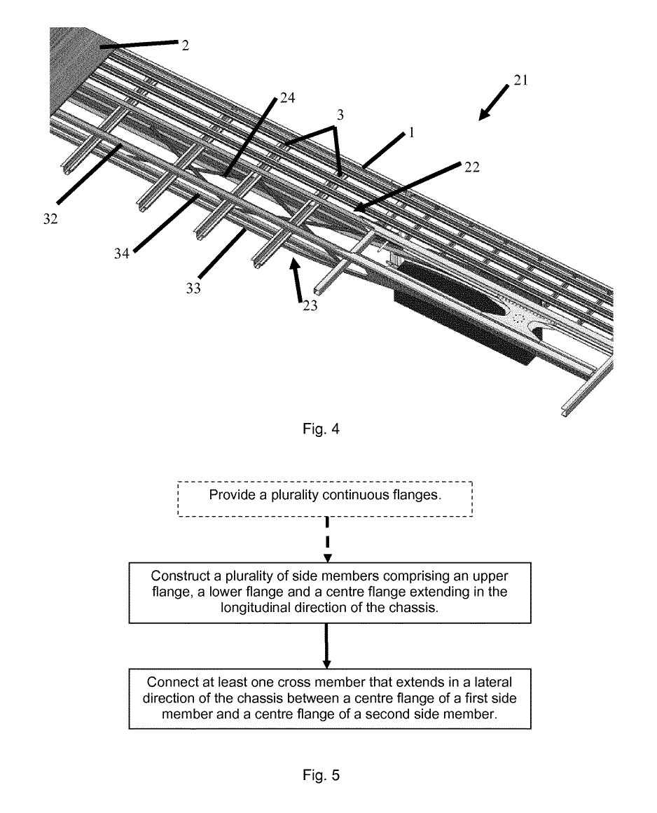

FIG. 4 shows a perspective view of a chassis 21 comprising two side members 22, 23, each comprising a an upper flange 32, a lower flange 33 and a centre flange 34. Cross members 24 connect the centre flanges 34 of the two adjacent side members 22, 23.

In the illustrated embodiment, the cross members 24 are in the form of a crossed lattice structure constructed from metal strips or bars of uniform thickness and cross section.

The cross members 24 may however be of any shape, size or cross section and may form a uniform or non-uniform pattern along at least a part of the length of the chassis 21. It should be noted that FIG. 4 shows a chassis 21 comprising two side members 22, 23, and a plurality of cross beams 3 which support a plurality of longitudinal frame rails 1 that extend in the longitudinal direction of the chassis 21 and which are arranged to support the floor 2 of the trailer for example. A chassis or a trailer chassis according to the present invention may however comprise any number of side members 22, 23 which for example support frame rails 1 and floor panels 2, and not only one side member 22, 23 on each outermost side of the chassis or trailer chassis.

Cross members 24 extending in the lateral direction of a chassis according to the present invention may be connected to side members 22, 23 by clamping their ends to the centre flanges 34 of the side members 22, 23. Such cross members 24 may however be connected to the centre flanges 34 in any suitable manner.

FIG. 5 is a flow chart showing the steps of a method according to an embodiment of the invention. The method comprises the optional step of providing a plurality of continuous flanges. A plurality of side members comprising an upper flange, a lower flange and a centre flange are constructed, which flanges are extended in a longitudinal direction of the chassis when the chassis has been constructed. The method comprises the step of mounting a centre flange between the upper flange and the lower flange of each side member which centre flange extends in the longitudinal direction of the chassis, and connecting at least one cross member that extends in a lateral direction of the chassis between a centre flange of a first side member of the plurality of side members and a centre flange of a second side member of the plurality of side members. Preferably all of the connections and bonds of components forming each side member are carried out using rivet and/or screw joints.

Further modifications of the invention within the scope of the claims would be apparent to a skilled person. For example, even though claim 1 recites a chassis comprising side members each having three flanges, it should be noted that the scope of claim 1 also covers chassis that comprise side members having more than three flanges. If a side member comprises more than three flanges then it will have one upper flange, one lower flange, and more than one centre flange. At least one cross member may then be connected between any of the plurality of centre flanges of a first side member and any of the plurality of centre flanges of a second side member.

1. Chassis comprising at least one wheel, and a plurality of side members each comprising an upper flange and a lower flange that extend in a longitudinal direction of the chassis, whereby the chassis comprises a centre flange that is located between the upper flange and the lower flange and extends in the longitudinal direction of the chassis, and at least one cross member that extends in a lateral direction of the chassis wherein said at least one cross member is connected only between a centre flange of a first side member of the plurality of side members and a centre flange of a second side member of the plurality of side members.

2. Chassis according to claim 1, wherein at least one of the upper flange, the lower flange and/or the centre flange have a continuous extension along the whole of a side member's length.

3. Chassis according to claim 1, wherein said at least one cross member comprises a rib, a plate or a lattice structure.

4. Chassis according to claim 1, wherein said centre flange of a side member extends in parallel with at least one of the upper flange or the lower flange.

5. Chassis according to claim 1, wherein said at least one cross member is arranged to be clamped between a centre flange of a first side member of the plurality of side members and a centre flange of a second side member of the plurality of side members.

6. Chassis according to claim 1, wherein it is a vehicle chassis, a trailer chassis, a rolling chassis or any chassis that is to be towed by pulling means.

7. Method for manufacturing a chassis comprising at least one wheel and a plurality of side members each comprising an upper flange and a lower flange that extend in a longitudinal direction of the chassis, whereby the method comprises the step of mounting a centre flange between the upper flange and the lower flange of each side member which centre flange extends in the longitudinal direction of the chassis, wherein it comprises the step of connecting at least one cross member that extends in a lateral direction of the chassis only between a centre flange of a first side member of the plurality of side members and a centre flange of a second side member of the plurality of side members.

8. Method according to claim 7, wherein it comprises the step of manufacturing at least one of the upper flange, the lower flange and/or the centre flange to have a continuous extension along the whole of a side member's length.

9. Method according to claim 7, wherein the at least one cross member comprises a rib, a plate or a lattice structure.

10. Method according to claim 7, wherein it comprises the step of arranging the centre flange of a side member to extend in parallel with at least one of the upper flange or the lower flange.

11. Method according to claim 7, wherein it comprises the step of clamping the at least one cross member between a centre flange of a first side member of the plurality of side members and a centre flange of a second side member of the plurality of side members.

12. Method according to claim 7, wherein the chassis is a vehicle chassis, a rolling chassis, a trailer chassis, or any chassis that is to be towed by pulling means.
